(19) United States
(12) Patent Application Publication
(10) Pub. No.: US 2015/0031426 A1
(43) Pub. Date: Jan. 29, 2015

(54) Visual Information Targeting Game

(71) Applicant: Ross Alloway, Jacksonville, FL (US)

(72) Inventor: Ross Alloway, Jacksonville, FL (US)

(21) Appl. No.: 14/341,575

(22) Filed: Jul. 25, 2014

Related U.S. Application Data
(60) Provisional application No. 61/858,494, filed on Jul. 25, 2013.

(51) Int. Cl. A63F 13/52; A63F 13/49; A63F 13/67; A63F 13/40

(52) U.S. Cl. CPC A63F 13/52; A63F 13/40; A63F 13/49; A63F 13/67
USPC 463/9

(57) ABSTRACT

The visual information targeting game challenges users to discern target objects from a plurality of distracting elements within a game space and then challenges the users to recall and select the previously selected target objects from another plurality of distracting elements in a new game space. Target objects are categorically related to one another. The target objects and the distracting elements are particularly arranged on each game space in either a random or context based distribution. Through the identification, selection, and recall of the target objects, a user is able to strengthen their ability to process the target objects.

The current application claims a priority to the U.S. Provisional Patent application Ser. No. 61/858,494 filed on Jul. 25, 2014.

### FIELD OF THE INVENTION

The present invention relates generally to a cognitive processing game, more specifically to a visual information targeting game that enhances cognitive processing of related information displayed as either text or symbols.

### BACKGROUND OF THE INVENTION

There are many fields where being able to quickly processes highly complex visual information is considered an essential skill In some of these fields, an individual reads graphs, maps, diagrams, or computer files/programs and would be required to discern what the key information is. Although processing highly complex visual information can depend greatly on an individual's natural abilities, any individual can significantly improve their abilities through training themselves using a cognitive training method. Cognitive training methods can help improves an individual's ability to process visual information helping them identify visual information, relevant to visually demanding tasks.

It is therefore the object of the present invention to provide a visual information targeting game that improves a user's cognitive ability to process visual information. The visual information targeting game accomplishes this by challenging a user to identify categorically related target objects from distracting visual stimuli on a game space. The visual information targeting game then has the user recall the previously selected target objects from distracting stimuli that include categorically related objects. Through the aforementioned steps, the user is able to improve their recognition and identification of a particular category of target objects as well as generally improve their ability to selectively identify a plurality of target objects from distracting visual stimuli.

### BRIEF DESCRIPTIONS OF THE DRAWINGS

FIG. 1 is a flow chart diagram displaying the general process overview of the visual information targeting game, as per the current embodiment of the present invention.

FIG. 2 is a block diagram displaying the processes elements utilized to define the game parameters.

FIG. 3 is a block diagram displaying some of the possible games modes that can be selected in the current embodiment of the present invention.

FIG. 4 is a block diagram displaying the first round and the second round as well as the displayed elements that are found within the first game space and the second game space.

FIG. 5 is an example of a particular arrangement of a game space configured with a randomized distribution.

FIG. 6 is another example of a particular arrangement of a game space configured with a randomized distribution.

FIG. 7 is an example of a particular arrangement of a game space configured with a context based distribution.

### DETAIL DESCRIPTIONS OF THE INVENTION

All illustrations of the drawings are for the purpose of describing selected versions of the present invention and are not intended to limit the scope of the present invention.

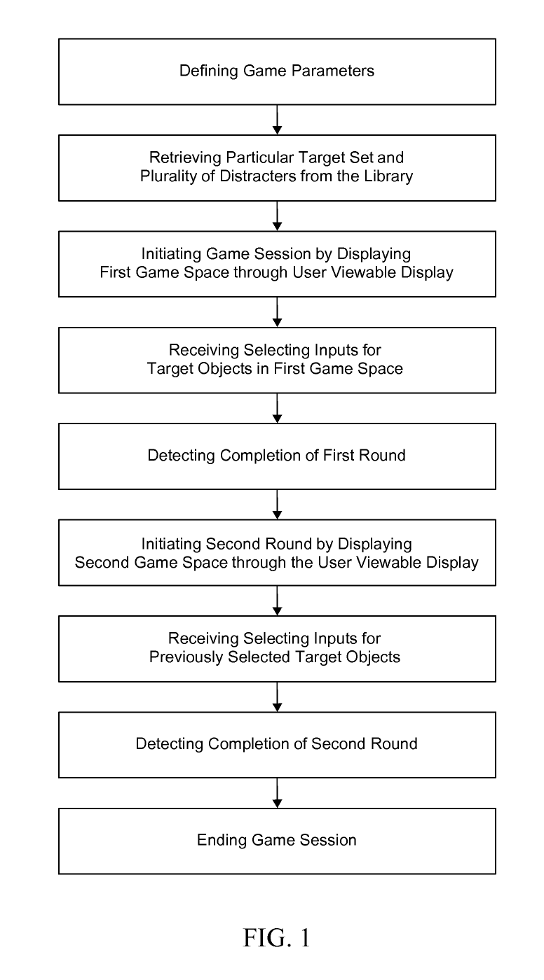

Referencing FIG. 1, the present invention is a visual information targeting game that helps train cognitive processing of visual information. The visual information targeting game challenges users to discern target objects from a plurality of distracting elements within a game space and then challenges the users to recall and select the previously selected target objects from another plurality of distracting elements in a new game space. Target objects are categorically related to one another. The target objects and the distracting elements are particularly arranged on each game space in either a random or context based distribution. Through the identification, selection, and recall of the target objects, a user is able to strengthen their ability to process the target objects.

The visual information targeting game operates through a system comprising a user viewable display, a user input means, and a library. The user viewable display serves as a visual interface between a user and the visual information targeting game. The user input means is the interaction point through which a user is able to select target objects and modify game parameters. It should be noted that in an embodiment of the present invention, the user input means and the user viewable display can be integrally related through the use of a touch screen display. The touch screen display combines the function of both the user viewable display and the user input means while additionally providing an ability to detect gesture inputs as selecting inputs. The library is a storage medium for the system that stores a plurality of target sets and a plurality of distracters. In an embodiment of the present invention, the library is provided with functionality enabling a user to upload and edit the plurality of target sets and the plurality of distracters.

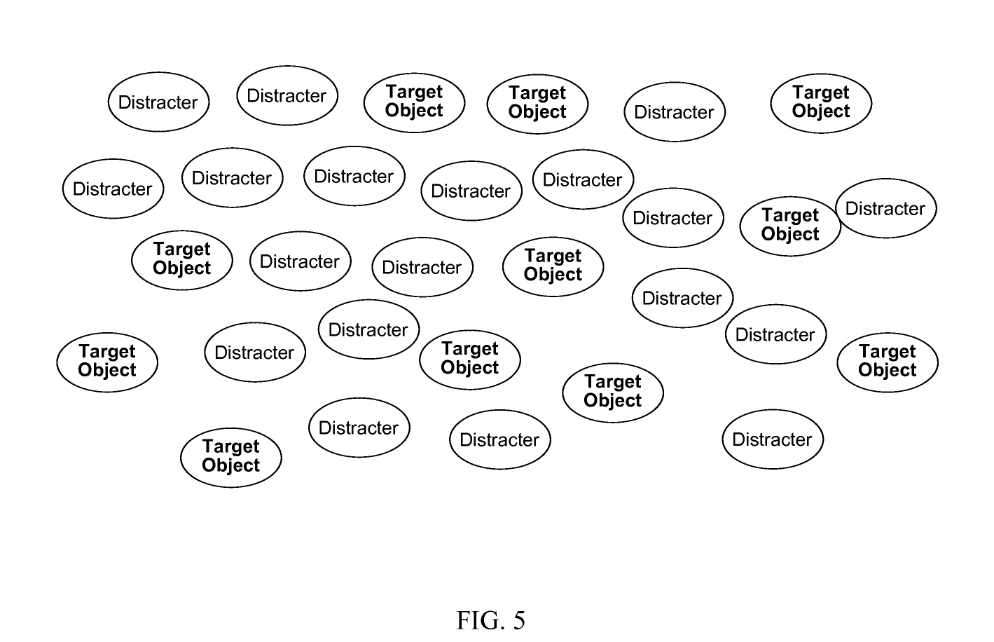

Referencing FIG. 5-7, the plurality of target sets and the plurality of distracters contain the particular elements that are distributed throughout a game space. Each target set of the plurality of target sets contains target objects. The target objects of a particular target set are related to one another through a categorical relationship. The categories of which the target objects can be related require a classification system that is definite. It should be noted that target objects are offered as either text or symbols and that the categorization of text would be derived by its meaning while symbols would generally be derived by association to the category. Furthermore, it should be noted that symbols can be any graphic object that is identifiable by a user and can include pictures, images, and icons. The plurality of distracters are distracting elements that are used to obfuscate attempts to identify target objects. Each distracter can be configured as text or symbols. When configured as either text or symbols, the distracters can be randomly generated or particularly selected based on the target set.

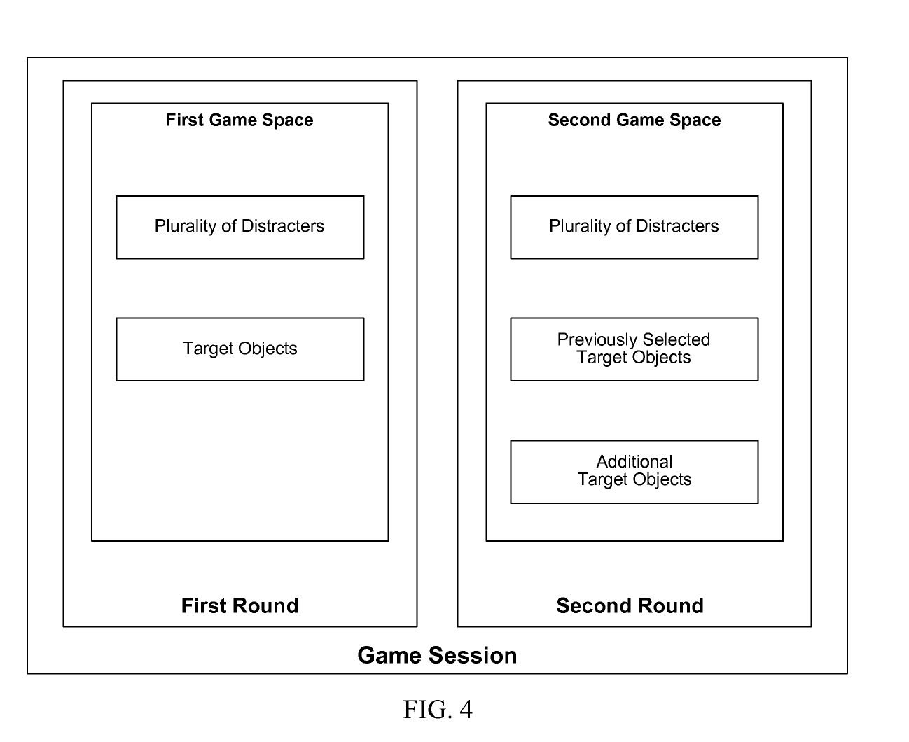

Referencing FIG. 4, the visual information targeting game is provided with a game session. The game session serves as a self contained playable interval for the visual information targeting game, where information or values generated during the game session are not directly carried over into another game session. It should be noted that while the generated information and values are not carried over into other game sessions, completion of a game session can influence difficulty setting of another game session depending on a game mode. In the current embodiment of the present invention, the game session comprises a first round and a second round. The first round and the second round are related subintervals of the game session, where information derived in the first round is utilized in the second round. In the preferred embodiment of the present invention, the target objects of the first round are utilized in the second round as previously selected target objects.

The visual information targeting game is accomplished through a series of steps. The series of steps utilized are best understood as a method of implementation for the visual information targeting game. In the current embodiment of the present invention, the visual information targeting game comprises the steps of defining game parameters for the game session, retrieving a particular target set and a plurality of distracters from the library, generating game spaces for the first round and the second round, initiating the game session, receiving selecting inputs during the first round, receiving selecting inputs during the second round, and ending the game session after the second round.

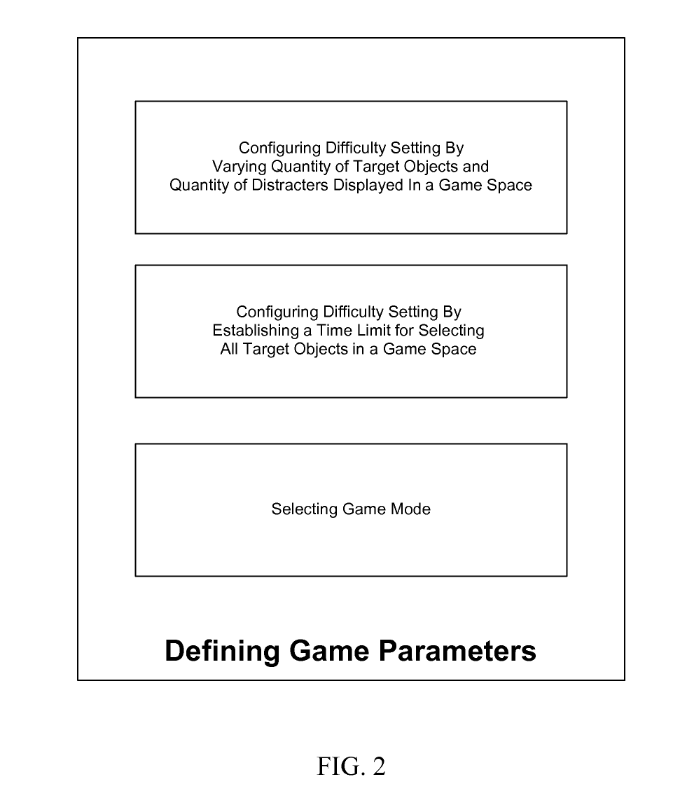

Referencing FIG. 2, the step of defining the game parameters is provided as a configuration step for the visual information targeting game. The game parameters are modified by selecting inputs received through the user input means. The selecting inputs modify values influencing difficulty of a game session as well as what occurs following the completion of a game session. In the current embodiment of the present invention, the game parameters comprise difficulty settings and game mode.

The step of defining the game parameters comprises configurations steps for the difficulty settings. The configuration of the difficulty settings changes the relative difficulty of a game session by adjusting quantity of targets objects and quantity of distracters found on a games space as well as incorporating a time limit for selecting all the target objects in the game space. In the current embodiment of the present invention, the difficulty settings are configured by varying the quantity of target objects and the quantity of distracters displayed in a game space. The difficulty of a game session with the aforementioned configuration is proportional to the relative quantities of the target objects and the quantities of distracters displayed in the game space. In the current embodiment of the present invention, the difficulty settings are also configurable through the inclusion of a time limit for selecting all target objects in the first round and all previously selected target objects in the second round. The difficulty of a game session with the aforementioned configuration carries an inverse relationship with the quantity of time provided in the time limit, as reducing the time allotted for selecting all target objects in the first round and all previously selected target objects in the second round increases in difficulty as the time allotted decreases. It should be noted that in an embodiment of the invention, the difficulty setting may be configured using a combination of varying the quantity of target objects and distracters as well as imposing a time limit for selecting all the target objects and all the previously selected target objects in the first round and second round, respectively.

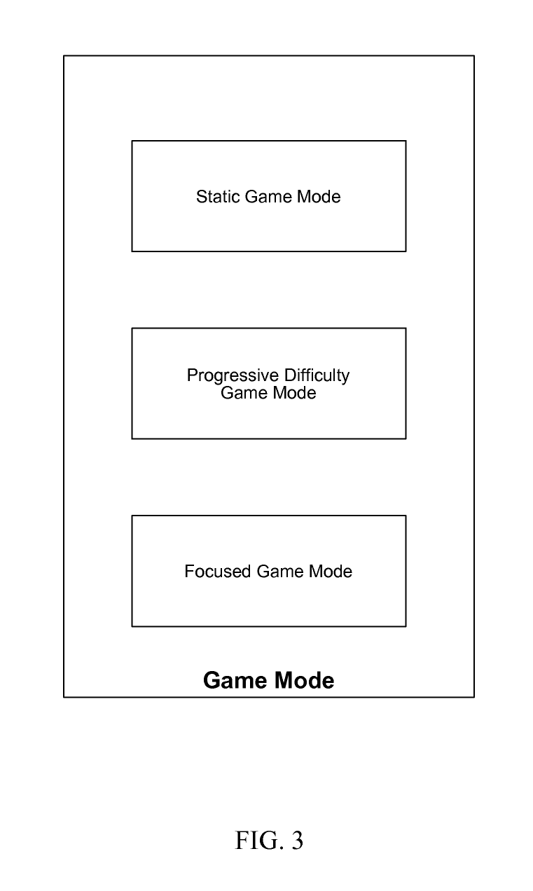

Referencing FIG. 3, the step of defining the game parameters comprises a step for selecting a game mode. The game mode provides instructions to the visual information targeting game on how to proceed following the completion of a game session. More specifically, the game mode provides instructions that initiates another game session and configures the new game session accordingly. In the current embodiment of the present invention, the game mode is selected from a group consisting of a static game mode, a progressive difficulty game mode, and a focused game mode. The static game mode, the progressive difficulty game mode, and the focused game mode initiate another game session upon completion of the second round of a previous game session. In the static game mode, the new game session maintains the same difficulty setting as the previous game session. In the progressive difficulty game mode, the difficulty setting of the new game session is increased relative to the difficulty setting of the previous game session. In the focused game mode, the difficulty setting for the new game session increases relative to the previous game session. Unlike the progressive difficulty game mode, the focused game mode utilizes the same particular target set as the previous game session. It should be noted that utilizing the same particular target set is provided as a means of focusing on target object in the category associated with the particular target set. Furthermore, it should be noted that in an additional embodiment of the invention, the static game mode may be configured to utilize the same particular target set as the previous game session.

In an additional embodiment of the present invention, a dynamic game mode is provided as an optional game mode. The dynamic game mode initiates another game session upon detecting the end of a previous game session. The dynamic game mode determines whether there was a successful or unsuccessful completion of the previous game session and then subsequently adjusting the difficulty settings accordingly. Upon determining successful completion of the previous game session, the dynamic game mode would increase the difficult settings for the new game session. Upon determining the unsuccessful completion of the previous game session, the dynamic game mode would decrease the difficulty setting for the new game session.

In the dynamic game mode, a submission mechanic and a review process would be provided for determining successful or unsuccessful completion of a game session. The submission mechanic allows a user to end a round at their discretion. When the round is ended by the user, the game space is submitted for inspection by the review process. The review process receives the game space and determine how many target objects were identified, through selecting inputs, by the user. The review process makes a determination of whether a successful completion or an unsuccessful completion of a round occurred. The determination is based on percentage of the target objects identified by the user. If the user selects a quantity of target objects that is greater than or equal to certain percentage of all the target objects on the game space, the review process would understand this situation as being indicative of a successful completion of the round. If the user selects a quantity of target objects that is less than the certain percentage of all the target objects on the game space, the review process would understand this situation as being indicative of an unsuccessful completion of the round. It should be noted that the submission mechanism and the review process could be incorporated into other game modes. The step of retrieving a particular target set and a plurality of distracters from the library is a necessary step for generating the game spaces for the game session. The retrieval step makes the target objects of a particular target set and the distracters of the plurality of distracters available for use in generating the game spaces for the game session. The retrieval step provides a distinct interaction with the library during the creation process of the game spaces but additionally ensure that modification and changes due to definitions in the game parameters are implemented in the game session.

Referencing FIG. 4, the step of generating the game spaces for the first round and the second round of a game session is required to occur prior to initiation of the game session. The game spaces are the displayed interfaces that contain particular arrangements of target objects and distracters that are selectable by a user. In the current embodiment of the present invention, the particular arrangement of the target objects and the plurality of distracters on a game space can be characterized as being in a random distribution or in a context based distribution. It should be noted that the particular arrangements for the game space of the first round and the game space of the second round do not have to be the same. Furthermore, it should be noted that particular arrangements utilized in the game spaces can be randomly selected during the generation step but can be user defined as well as defined based on the particular target set. Moreover, in an additional embodiment the selection of the particular arrangements of the target objects and the plurality of distracters can be configured during the configuration step of the game parameters.

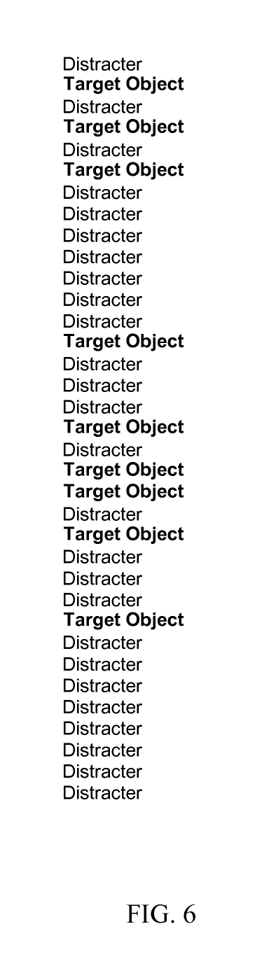

Referencing FIG. 5 and FIG. 6, the particular arrangements using a random distribution of the target objects and the plurality of distracters displays the target objects in the game space with no specific relationship pattern to the plurality of distracters. In an exemplary embodiment, the particular arrangement would be provided as a list and the randomized distribution would consist of the target objects being positioned in a random order relative to the distracters on the list. In another exemplary embodiment, the particular arrangement would be provided as a word cloud type arrangement and the randomized distribution would position the target objects and the plurality of distracters throughout the game space permitted the target objects and the distracters maintain a particular orientation and do not overlap. It should be understood that random distribution would be accomplished through a computational device and would thus not be truly random.

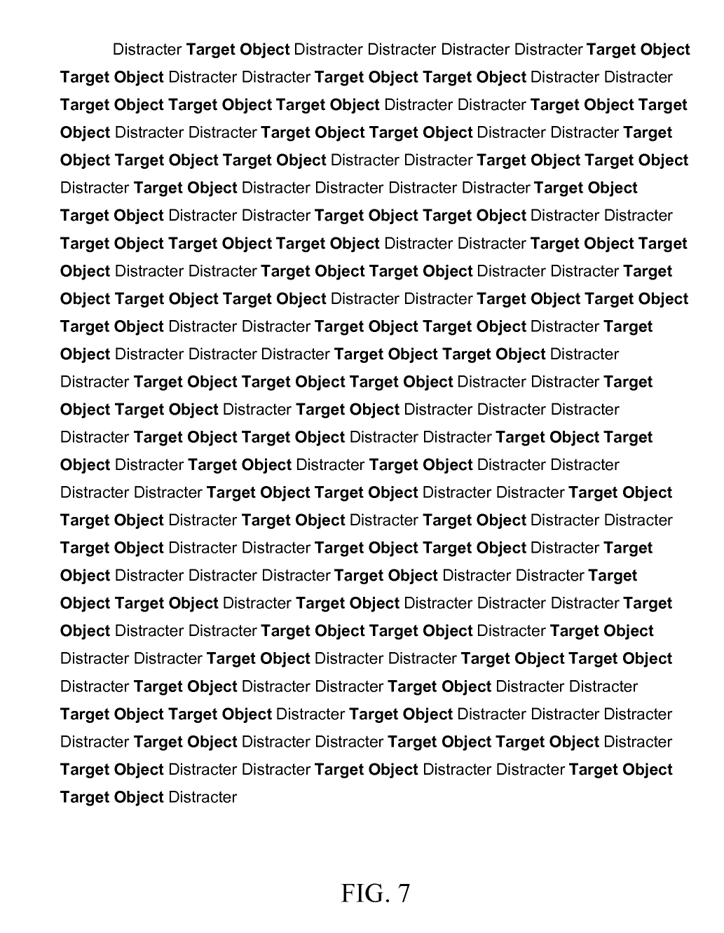

Referencing FIG. 7, the particular arrangement using context based distribution of the target objects with the plurality of distracters displays distracters particularly selected for the target objects as well as places the target objects in a particular position relative to each target object. In an exemplary embodiment, the particular arrangement would be configured as a passage where the target objects would be key words within the passage while the plurality of distracters would be the remaining text that provides structure to the passage. In another exemplary embodiment, the distracters would be derived based on context of the target object but could be positioned in anywhere throughout the game space.

Referencing FIG. 4, a game space is generated for each round of the game session. A first game space and a second game space are generated for the first round and the second round, respectively. Although the first game space and the second game space contain the same elements, target objects and distracters, the first game space creates an association with selected target objects that is carried over into the second game space.

In the current embodiment of the present invention, the first game space for the first round is generated using target objects from the particular target set and distracters from the plurality of distracters. The target objects and the distracters are particularly arranged throughout the first game space based on a randomized distribution or a context based distribution. It should be noted that the quantity of target objects and the quantity of distracters positioned within the first game space would be determined based on the difficulty settings defined in the game parameters.

In the current embodiment of the present invention, the second game space for the second round is generated using previously selected target objects from the first game space, additional target objects from the particular target set, and distracters from the plurality of distracters. The previously selected target objects utilized in the generation of the first game space are carried over from the first round and utilized in the second game space. Additional target objects are retrieved from the same particular targets set and are used in addition with the previously selected target objects. Similar to the generation of the first game space, a plurality of distracters are also utilized. The previously selected target objects, the additional target objects from the particular target set, and the distracters are particularly arranged through the second game space based on a randomized distribution or a context based distribution. It should be noted that the quantity of the additional target objects and the quantity of distracters positioned within the second game space would be determined based on the difficulty settings defined in the game parameters. Furthermore it should be noted that the additional target objects utilized in the game space function as distracters due to the objective of the second round. It should be noted that in an embodiment of the invention, the second game space could exclude the user of distracters from the library and rely on the additional target objects from the particular target set to accomplish the same purpose.

The step of initiating the game session occurs when the first game space is displayed through the user viewable display. The display of the first game space connotes the initiation of the first round of the game session. Upon displaying the first game space, the system awaits the selecting inputs from the user input means for the target objects. It should be noted that depending on the difficulty settings, a game timer would be initiated at the same time instance as the first game space is displayed.

The step of receiving selecting inputs through the user input means for the target objects in the first game space occurs during the course of the first round. Upon initiation of the first round the system awaits selecting input for the target objects on the first game space. The system would interpret the final selecting input, indicating selection of all the target objects, as signifying the completion of the first round. It should be noted that a response for receiving a selecting input for a distracter is not explicitly described and could be accomplished as an error message but could additionally generate no response, at which point the selection of a distracter could prevent completion of the first round.

The step of displaying the second game space on the user viewable display occurs following the completion of the first round. Completion of the first round is detected following the selection of all the target objects on the first game space. After the first round is completed the first game space is removed from the user viewable display and replaced by the second game space. The displaying of the second game space is the initiating instance of the second round. It should be noted that depending on the difficulty settings, a game timer would be initiated at the same time instance as the second game space is displayed.

The step of receiving selecting input through the user input means for the previously selected target objects occurs during the second round. Following the initiation of the second round, the system await for selecting input that identifying the previously selected target objects from the additional target objects and the plurality of distracters. The system would interpret the final selecting input, indicating selection of all the previously selected target objects, as the completion of the second round and the completion of the game session. It should be noted that a response for receiving a selecting input for a distracter or an additional target object is not explicitly described and could be accomplished as an error message but could additionally generate no response, at which point the selection of a distracter could prevent completion of the second round.

The step of ending the second round is provided as a finalizing step that ends the game session. The system detects the completion of the second round as the end point for the game session. Upon detecting completion of the game session, the system refers back to the game parameters to determine subsequent actions. The subsequent actions are influence the initiation of another game session but additionally influence the configuration of the new game session. It should be noted that in an additional embodiment, completion of a game session would be accomplished through the use of a submission mechanic and a review process. The submission mechanic and the review process would be used to make a determination of whether a game session was completed successfully or unsuccessfully. The submission mechanic would allow a user to end a round at their discretion. When the round is ended by the user, the game space would be submitted for inspection by the review process. The review process would receive the game space and determine how many target objects were identified, through selecting inputs, by the user. The review process would makes a determination of whether a successful completion or an unsuccessful completion of a round occurred. The determination would be based on percentage of the target objects identified by the user. If the user selects a quantity of target objects that is greater than or equal to certain percentage of all the target objects on the game space, the review process would understand this situation as being indicative of a successful completion of the round. If the user selects a quantity of target objects that is less than the certain percentage of all the target objects on the game space, the review process would understand this situation as being indicative of an unsuccessful completion of the round.

In an additional embodiment of the invention, the selecting inputs utilized to select a target object during the game session could include additional interactions that would enhance cognitive processing. In the aforementioned embodiment of the invention a user could be required to enter a selecting input that would consist of a line segment that joins a target object on the game space with another target object within the same game space. The resulting interaction would create a web joining all the target objects through a continuous line segment. It should be noted that in the aforementioned embodiment, a user input means accomplished through a touch screen interface would be optimally suited for the interactions but could be accomplished through other input means such as a mouse.

Although the invention has been explained in relation to its preferred embodiment, it is to be understood that many other possible modifications and variations can be made without departing from the spirit and scope of the invention as hereinafter claimed.

What is claimed is:

1. A visual information targeting game comprises the steps of:
providing a system comprising a user viewable display, a user input means, and a library;
providing the library comprising a plurality of target sets and a plurality of distracters, wherein each target set of the plurality of target sets comprise categorically related target objects;
providing a game session, wherein each game session comprises a first round and a second round;
defining game parameters, wherein the game parameters comprise a difficulty setting and a game mode;
retrieving a particular target set from the plurality of target sets and a plurality of distracters from the library;
generating game spaces for the first round and second round of the game session using the particular target set and the plurality of distracters, wherein a first game space is generated for the first round and a second game space is generated for the second round;
initiating the game session by displaying the first game space through a user viewable display;
receiving selecting inputs, through the user input means, selecting target objects in the first game space;
displaying the second game space through the user viewable display upon detecting completion of the first round;
receiving selecting inputs, through the user input means, for previously selected target objects in the second game space; and
ending game session upon detecting completion of the second round.

2. The visual information targeting game as claimed in claim 1, wherein the selecting inputs are gesture inputs, where the user viewable display provides functionality as the user input means recognizing gesture inputs.

3. The visual information targeting game as claimed in claim 1, wherein the library stores a plurality of target sets and a plurality of distracters submitted by users.

4. The step of defining game parameters as claimed in claim 1 comprises the steps of:
configuring difficulty setting for a game session by varying the quantity of target objects and the quantity of distracters displayed in a game space, wherein the difficulty setting is proportional to the relative quantities of the target objects and the quantities of distracters displayed in the game space.

5. The step of defining game parameters as claimed in claim 1 comprises the steps of:
configuring difficulty setting for a game session by setting a time limit for selecting all target objects in the first round and all previously selected target objects in the second round, wherein the difficulty setting is inversely proportional to the amount of time providing for the time limit.

6. The step of defining game parameters as claimed in claim 1 comprises the steps of:
selecting a game mode from a group comprising a static game mode, a progressive difficulty game mode, and a focused game mode;
wherein the static game mode initiates another game session upon completion of the second round of a previous game session while maintaining same difficulty setting as the previous game session;
wherein the progressive difficulty game mode initiates another game session upon completion of the second round of a previous game session, where the initiated game session having increased difficulty settings relative to the previous game session; and
wherein the focused game mode initiates another game session upon completion of the second round of a previous game session, where the initiated game session having increased difficulty settings relative to the previous game session and utilizing the same particular target set as the previous game session.

7. The step of selecting a game mode as claimed in claim 6, wherein the static game mode additionally utilizes the same particular target set as the previous game session.

8. The step of selecting a game mode as claimed in claim 6 comprises the steps of:
selecting a game mode from a group comprising a dynamic game mode; and
wherein the dynamic game mode initiates another game session having difficulty settings adjusted relative to a previous game session dependent on successful or unsuccessful completion of the previous game session, where successful completion would result in increased difficult settings while unsuccessful would result in decreased difficulty settings.

9. The step of generating a game space as claimed in claim 1 comprises the steps of:
generating a first game space for the first round using target objects from the particular target set and distracters from the plurality of distracters, wherein the target objects from the particular target set and the distracters being particularly arranged on the first game space; and
generating a second game space for the second round using previously selected target objects from the first game space, additional target objects from the particular target set, and distracters from the plurality of distracters, wherein the previously selected target objects, the additional target objects from the particular target set, and the distracters being particularly arranged on the second game space.

10. The step of generating game space as claimed in claim 1 comprises the steps of:
generating at least one game space particularly arranging the target objects of the particular target set and the distracters of the plurality of distracters in a randomized distribution.

11. The step of generating game space as claimed in claim 1 comprises the steps of:
generating at least one game space particularly arranging the target objects of the particular target set and the distracters of the plurality of distracters in a context based distribution, wherein the positioning of the target objects is related to the positioning of the distracters.

12. The step of displaying the second game space as claimed in claim 1 comprises the steps of:
detecting completion of the first round upon receiving selecting inputs for all target objects in the first game space.

13. The step of ending the game session as claimed in claim 1 comprises the steps of:
detecting completion of the second round upon receiving the selecting inputs for all previously selected target objects in the second game space; and
determining subsequent game session action based on game mode configurations.
